(19) United States
(12) Patent Application Publication
(10) Pub. No.: US 2026/0190125 A1
(43) Pub. Date: Jul. 2, 2026

(54) MULTI-SLOT SIDELINK CONTROL INFORMATION SCHEDULING

(71) Applicant: Lenovo (Singapore) Pte. Ltd., Singapore (SG)

(72) Inventors: Karthikeyan Ganesan, Nauheim (DE); Alexander Golitschek Edler von Elbwart, Darmstadt (DE)

(21) Appl. No.: 19/127,385

(22) PCT Filed: Nov. 6, 2023
(86) PCT No.: PCT/IB2023/061195

§ 371 Date: May 5, 2025

Related U.S. Application Data
(60) Provisional application No. 63/422,889, filed on Nov. 4, 2022.

(51) Int. Cl. H04W 72/25; H04L 1/1867

(52) U.S. Cl. CPC H04W 72/25; H04L 1/1896

(57) ABSTRACT

Various aspects of the present disclosure relate to multi-slot sidelink control information (SCI) scheduling. A UE may be configured to initiate a channel occupancy time (COT) and to transmit a first-stage SCI scheduling a plurality of contiguous slots associated with the COT. The UE may be configured to indicate the presence or absence of a respective SCI in a corresponding slot of the plurality of contiguous slots and to transmit a plurality of transmission.

### TECHNICAL FIELD

The present disclosure relates to wireless communications, and more specifically to schemes for multi-slot sidelink control information (SCI) scheduling.

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

Sidelink (SL) communication refers to peer-to-peer communication directly between UEs. Accordingly, the UEs communicate with one another without the communications being relayed via the mobile network (i.e., without the need of a base station).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include a transmitting UE (Tx UE) comprising a means for initiate a channel occupancy time (COT); transmit a first-stage SCI (SCI-1) scheduling a plurality of contiguous slots associated with the COT. The Tx UE described herein may further comprise a means for indicating the presence or absence of a respective SCI in a corresponding slot of the plurality of contiguous slots. The Tx UE described herein may further comprise a means for transmitting a plurality of transport blocks (TBs) during the plurality of contiguous slots.

Some implementations of the method and apparatuses described herein may include a receiving UE (Rx UE) comprising a means for receive a SCI-1 scheduling a plurality of contiguous slots associated with a COT. The Rx UE described herein may further comprise a means for receiving an indication of the presence or absence of a respective SCI in a corresponding slot of the plurality of contiguous slots. The Rx UE described herein may further comprise a means for receiving at least one transport block (TB) during the plurality of contiguous slots and transmitting Hybrid Automatic Repeat Request (HARQ) feedback corresponding to the at least one TB.

### BRIEF DESCRIPTION OF THE DRAWINGS

FIG. 1 illustrates an example of a wireless communication system in accordance with aspects of the present disclosure.

FIG. 2 illustrates an example of a Third Generation Partnership Project (3GPP) New Radio (NR) protocol stack showing different protocol layers in the UE and network, in accordance with aspects of the present disclosure.

FIG. 3 illustrates an example of a sidelink (SL) protocol stack, in accordance with aspects of the present disclosure.

FIG. 4 illustrates an example of a multiple transmission time interval (multi-TTI) Downlink Control Information (DCI) grant for four slots, in accordance with aspects of the present disclosure.

FIG. 5A illustrates an example of a multi-TTI first-stage SCI (SCI-1) grant for three slots with a common second-stage SCI (SCI-2), in accordance with aspects of the present disclosure.

FIG. 5B illustrates an example of a multi-TTI SCI-1 grant for three slots with a transport block (TB)-specific SCI-2, in accordance with aspects of the present disclosure.

FIG. 6 illustrates an example of a SCI-1 that schedules the presence/absence of SCI-2 in other slots, in accordance with aspects of the present disclosure.

FIG. 7 illustrates an example of a first SCI-2 that schedules additional SCI-2 in other slots, in accordance with aspects of the present disclosure.

FIG. 8 illustrates an example of a SCI-2 that schedules the presence/absence of a subsequent SCI-2 in the next slot, in accordance with aspects of the present disclosure.

FIG. 9 illustrates an example of incrementing a HARQ process identity (HPID), in accordance with aspects of the present disclosure.

FIG. 10 illustrates an example of a DeModulation Reference Signal (DMRS) bundling indication, in accordance with aspects of the present disclosure.

FIG. 11 illustrates an example of a user equipment (UE) 1100, in accordance with aspects of the present disclosure.

FIG. 12 illustrates an example of a processor 1200, in accordance with aspects of the present disclosure.

FIG. 13 illustrates an example of a network equipment (NE) 1300, in accordance with aspects of the present disclosure.

FIG. 14 illustrates a flowchart of a first method performed by a Tx UE, in accordance with aspects of the present disclosure.

FIG. 15 illustrates a flowchart of a second method performed by a Rx UE, in accordance with aspects of the present disclosure.

### DETAILED DESCRIPTION

Generally, the present disclosure describes systems, methods, and apparatuses for multi-slot SCI scheduling. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

Sidelink unlicensed operation is gaining momentum in 3GPP Release 18 (Rel-18) work item and the transmission over the unlicensed spectrum for channels such as Physical Uplink Shared Channel (PUSCH), Physical Uplink Control Channel (PUCCH) format 2 etc., should meet the Power Spectral Density (PSD) regulation and minimum channel occupancy (e.g., 80%). To fulfill these regulations interlacing methods were defined in LTE-U and NR-U by interlacing PUSCH and PUCCH channels at resource block level. Sub-Physical Resource Block (PRB) based interlacing was discussed during NR Release 16 (Rel-16) considering higher Subcarrier Spacing (SCS) but eventually not agreed.

In NR Rel-16 sidelink resource allocation, the minimum scheduling unit is defined by sub-channel consisting of ‘N’ PRBs and ‘M’ sub-channels constitute a resource pool. Each SL carrier contains one SL bandwidth part (BWP) which is then associated with multiple Tx Resource pools containing different configuration of the sub-channel sizes {n10, n12, n15, n20, n25, n50, n75, n100}. The minimum scheduling unit of sub-channel for sidelink contradicts that of uplink which is based on Resource Block (RB) level scheduling unit and each resource pool in sidelink does not span across entire bandwidth or Listen-Before-Talk (LBT) subbands which is the require from minimum occupancy and PSD limit.

In SL-U Rel-18, multi-slot Physical Sidelink Shared Channel (PSSCH) transmissions is agreed so that the UE after acquiring the channel may contiguously transmit PSSCH in the channel occupancy duration to one or more receive UEs/destination IDs.

The present disclosure provides details of the multi slot PSSCH transmission, whereby signaling efficiency is improved by not transmitting SCI-1 and SCI-2 in each time slot. In certain embodiments, the Tx UE may indicate the presence of subsequent SCI (e.g., SCI-1 and/or SCI-2) in a subsequent time slot to avoid having the Rx UE perform blind decoding to determine the presence/absence of second SCI.

Aspects of the present disclosure are described in the context of a wireless communications system.

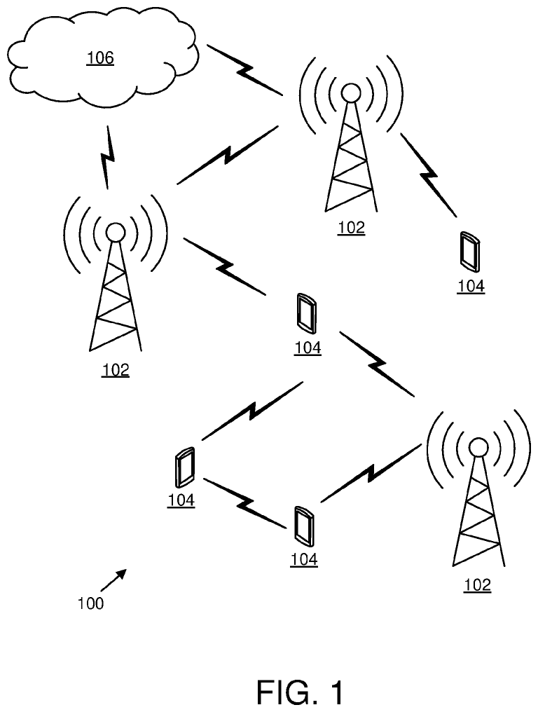

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

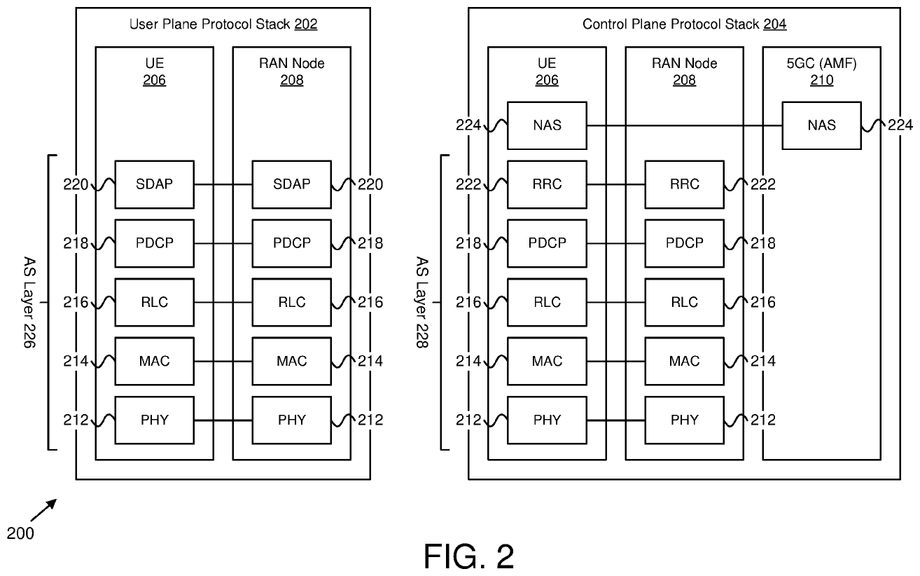

FIG. 2 illustrates an example of a NR protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a Physical (PHY) layer 212, a MAC sublayer 214, a Radio Link Control (RLC) sublayer 216, a Packet Data Convergence Protocol (PDCP) sublayer 218, and a Service Data Adaptation Protocol (SDAP) sublayer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP sublayer 220, PDCP sublayer 218, RLC sublayer 216, and MAC sublayer 214. The Layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in Multiple-Input Multiple-Output (MIMO) communication (also referred to as a “MIMO layer” or a “data stream”).

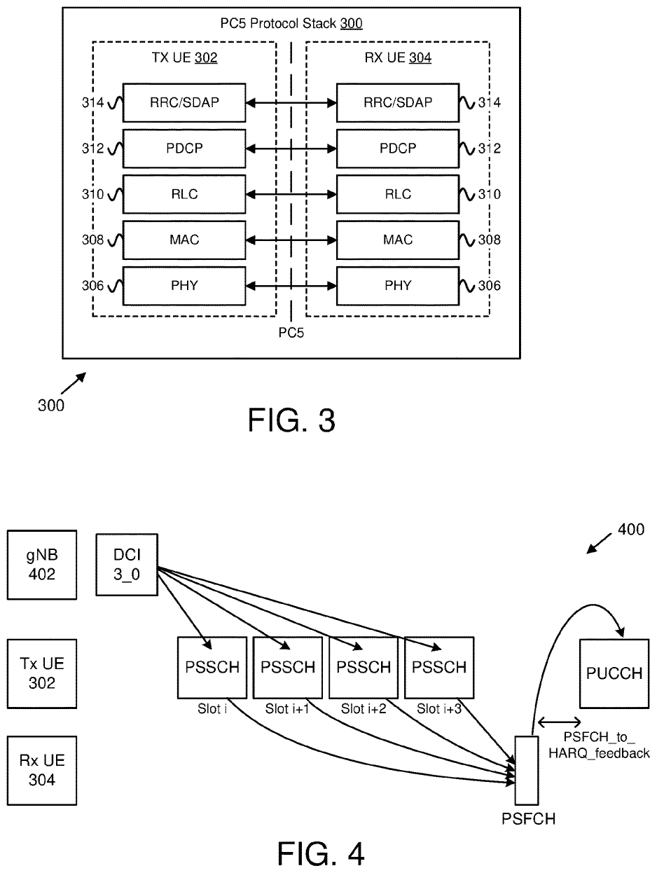

FIG. 3 illustrates a SL protocol stack 300, in accordance with aspects of the present disclosure. While FIG. 3 shows a transmitting SL UE (denoted “Tx UE”) 302 and a receiving SL UE (denoted “Rx UE”) 304, these are representative of a set of UEs using SL communication over a PC5 interface; other embodiments may involve different SL UEs. In various embodiments, each of the Tx UE 302 and the Rx UE 304 may be an embodiment of the UE 104 and/or the UE 206.

As depicted, the SL protocol stack 300 (i.e., PC5 protocol stack) includes a PHY layer 306, a MAC sublayer 308, a RLC sublayer 310, a PDCP sublayer 312, a SDAP sublayer (e.g., for the user plane), and an RRC sublayer (e.g., for the control plane). In FIG. 3, the SDAP sublayer and RRC sublayer are depicted as combined entity “RRC/SDAP layers” 314. There may be additional layers above the RRC/SDAP layers 314, such as a Proximity Services (ProSe) and/or V2X application layer 316.

The AS layer (also referred to as “AS protocol stack”) for the control plane in the PC5 interface consists of at least the RRC sublayer, the PDCP sublayer 312, the RLC sublayer 310, the MAC sublayer 308, and the PHY layer 306. The AS layer (also referred to as “AS protocol stack”) for the user plane in the PC5 interface consists of at least the SDAP sublayer, the PDCP sublayer 312, the RLC sublayer 310, the MAC sublayer 308, and the PHY layer 306.

Similar to the NR protocol stack 200, the L1 refers to the PHY layer 306. The L2 is split into the SDAP sublayer, the PDCP sublayer 312, the RLC sublayer 310, and the MAC sublayer 308. The L3 includes the RRC sublayer for the control plane and includes, e.g., an IP layer or PDU Layer (not depicted) for the user plane. L1 and L2 are generally referred to as “lower layers,” while L3 and above (e.g., transport layer, V2X layer, application layer) are referred to as “higher layers” or “upper layers.” The PHY layer 306, the MAC sublayer 308, the RLC sublayer 310, and the PDCP sublayer 312 perform similar functions as the PHY layer 212, the MAC sublayer 214, the RLC sublayer 216, and the PDCP sublayer 218, described above with reference to FIG. 2.

In various embodiments, the SL communication relates to one or more services requiring SL connectivity, such as V2X services and ProSe services. The Tx UE 302 may establish one or more SL connections with nearby Rx UE 304. For example, a V2X application running on the Tx UE 302 may generate data relating to a V2X service and use a SL connection to transmit the V2X data to one or more nearby Rx UE 304.

First-stage SCI is carried on the Physical Sidelink Control Channel (PSCCH), while second-stage SCI is carried on the PSSCH. First-stage SCI is used to indicate resource reservation and may contain control information associated with the PSSCH and the second-stage SCI. SCI format 1-A is a format for first-stage SCI and is used for the scheduling of PSSCH and for scheduling second-stage SCI on PSSCH. The following information is transmitted by means of the SCI format 1-A: Priority, Frequency resource assignment, Time resource assignment, Resource reservation period, DMRS pattern, Second-stage SCI format, Beta_offset indicator, MCS, an Additional MCS table indicator, a Physical Sidelink Feedback Channel (PSFCH) overhead indication, a set of Reserved bits. In certain embodiments, the SCI format 1-A may also include a conflict information receiver flag.

The Priority information may comprise a 3-bit field (e.g., as specified in clause 5.4.3.3 of 3GPP Technical Specification (TS) 23.287 and clause 5.22.1.3.1 of 3GPP TS 38.321). In certain embodiments, a value ‘000’ of the Priority field corresponds to priority value ‘l’, value ‘001’ of Priority field corresponds to priority value ‘2’, and so on.

The Frequency resource assignment information may comprise a field with size of

$$⌈ {log}_{2} ( \frac{{N}_{subChannel}^{SL} ( {N}_{subChannel}^{SL} + 1 )}{2} ) ⌉$$

bits when the value of the higher layer parameter sl-MaxNumPerReserve is configured to 2; otherwise, this field may be of size

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉$$

bits, when the value of the higher layer parameter sl-MaxNumPerReserve is configured to 3, as defined in clause 8.1.5 of 3GPP TS 38.214.

The Time resource assignment information may comprise a 5-bit field when the value of the higher layer parameter sl-MaxNumPerReserve is configured to 2; otherwise, this field may be 9 bits when the value of the higher layer parameter sl-MaxNumPerReserve is configured to 3, as defined in clause 8.1.5 of 3GPP TS 38.214.

The Resource reservation period information may comprise a field with size of ┌log₂ N_{rsv_period}┐ bits (e.g., as defined in clause 16.4 of 3GPP TS 38.213), where N_{rsv_period} is the number of entries in the higher layer parameter sl-ResourceReservePeriodList, if higher layer parameter sl-MultiReserveResource is configured; otherwise, if higher layer parameter sl-MultiReserveResource is not configured, then this field may have a size of 0 bit.

The DMRS pattern information may comprise a field with size of ┌log₂ Nₚₐₜₜₑᵣₙ┐ bits (e.g., as defined in clause 8.4.1.1.2 of 3GPP TS 38.211), where Nₚₐₜₜₑᵣₙ is the number of DMRS patterns configured by higher layer parameter sl-PSSCH-DMRS-TimePatternList.

The Second-stage SCI format information may comprise a 2-bit field whose values are defined in Table 1, below.

The Beta_offset indicator information may comprise a 2-bit field as provided by higher layer parameter sl-BetaOffsets2ndSCI and whose values are defined in Table 2, below.

The Number of DMRS port information may comprise a 1-bit field whose values are defined in Table 3, below.

The MCS information may comprise a 5-bit field (e.g., as defined in clause 8.1.3 of 3GPP TS 38.214).

The Additional MCS table indicator information may comprise a 1-bit field if one MCS table is configured by higher layer parameter sl-Additional-MCS-Table; or this may be a 2-bit field if two MCS tables are configured by higher layer parameter sl-Additional-MCS-Table; otherwise, this is a field with size of 0 bit.

The PSFCH overhead indication information may comprise a 1-bit field (e.g., as defined clause 8.1.3.2 of 3GPP TS 38.214) if higher layer parameter sl-PSFCH-Period=2 or 4; otherwise, this is a field with size of 0 bit.

The Reserved information may comprise a number of bits as determined by the following: N_{reserved} bits as configured by higher layer parameter sl-NumReservedBits, with value set to zero, if higher layer parameter indicationUEBScheme2 is not configured, or if higher layer parameter indicationUEBScheme2 is configured to ‘Disabled’; and (N_{reserved}−1) bits; otherwise, with value set to zero.

The Conflict information receiver flag may be 0 or 1 bit. This information is a 1-bit flag if higher layer parameter indicationUEBScheme2 is configured to ‘Enabled’, where the bit value of 0 indicates that the UE cannot be a UE to receive conflict information and the bit value of 1 indicates that the UE can be a UE to receive conflict information as defined in Clause 16.3.0 of 3GPP TS 38.213; otherwise, this information is a 0-bit flag.

TABLE 1
Second-Stage SCI formats

| Value of 2nd-stage SCI format field | 2nd-stage SCI format |
|---|---|
| 00 | SCI format 2-A |
| 01 | SCI format 2-B |
| 10 | SCI format 2-C |
| 11 | Reserved |

TABLE 2
Mapping of Beta_offset indicator values

| | Beta_offset index in Table 9.3-2 |
|---|---|
| Value of Best_offset indicator | of 3GPP TS 38.213 |
| 00 | 1st index provided by higher layer |
| | parameter sl-BetaOffsets2ndSCI |
| 01 | 2nd index provided by higher layer |
| | parameter sl-BetaOffsets2ndSCI |
| 10 | 3rd index provided by higher layer |
| | parameter z |
| 11 | 4th index provided by higher layer |
| | parameter sl-BetaOffsets2ndSCI |

TABLE 3
Number of DMRS port(s)

| Value of the Number of DMRS port field | Antenna Port(s) |
|---|---|
| 0 | 1000 |
| 1 | 1000 and 1001 |

In various embodiments, the second-stage SCI (SCI-2) may carried on PSSCH. The SCI-2 indicates SL scheduling information and/or inter-UE coordination related information. The formats for SCI-2 include SCI format 2-A, SCI format 2-B, and SCI format 2-C. Regarding the SCI-2 formats, the fields defined in each of the SCI-2 formats below are mapped to the information bits a₀ to a_{A-1} as follows:

Each field is mapped in the order in which it appears in the description, with the first field mapped to the lowest order information bit a₀ and each successive field mapped to higher order information bits. The most significant bit of each field is mapped to the lowest order information bit for that field, e.g., the most significant bit of the first field is mapped to a₀.

Regarding SCI format 2-A, the SCI format 2-A is used for the decoding of PSSCH, with HARQ operation when HARQ-ACK information includes a Positive Acknowledge (ACK) or a Negative Acknowledge (NACK), when HARQ-ACK information includes only NACK, or when there is no feedback of HARQ-ACK information. As used herein, HARQ-ACK may represent collectively the ACK and the NACK. ACK means that a Transport Block (TB) is correctly received while NACK means a TB is erroneously received.

The following information is transmitted by means of the SCI format 2-A: HARQ process number, New Data Indicator (NDI), Redundancy Version (RV), Source Identifier (ID), Destination ID, HARQ feedback enabled/disabled indicator, Cast type indicator, and Channel State Information (CSI) request.

The HARQ process number information may comprise a 4-bit field. Note that the HARQ process number is also referred to as the “HARQ process ID”. The NDI information may comprise a 1-bit field. The RV information may comprise a 2-bit field (e.g., as defined in Table 7.3.1.1.1-2 of 3GPP TS 38.212). The Source ID information may comprise an 8-bit field (e.g., as defined in clause 8.1 of 3GPP TS 38.214). The Destination ID information may comprise a 16-bit field (e.g., as defined in clause 8.1 of 3GPP TS 38.214).

The HARQ feedback enabled/disabled indicator information may comprise a 1-bit field (e.g., as defined in clause 16.3 of 3GPP TS 38.213). The Cast type indicator information may comprise a 2-bit field, whose values are defined in Table 4, below. Further definitions of the cast types in Table 4 may be found in clause 8.1 of 3GPP TS 38.214. The CSI request information may comprise a 1-bit field (e.g., as defined in clause 8.2.1 of 3GPP TS 38.214 and in clause 8.1 of 3GPP TS 38.214).

TABLE 4
Mapping of Cast type indicator values

| Value of Cast type indicator | Cast Type |
|---|---|
| 00 | Broadcast |
| 01 | Groupcast when HARQ-ACK information |
| | includes ACK or NACK |
| 10 | Unicast |
| 11 | Groupcast when HARQ-ACK information |
| | includes only NACK |

Regarding SCI format 2-B, the SCI format 2-B is used for the decoding of PSSCH, with HARQ operation when HARQ-ACK information includes only NACK, or when there is no feedback of HARQ-ACK information.

The following information is transmitted by means of the SCI format 2-B: HARQ process number, NDI, RV, Source ID, Destination ID, HARQ feedback enabled/disabled indicator, Zone ID, and Communication range requirement.

The HARQ process number information may comprise a 4-bit field. The NDI information may comprise a 1-bit field. The RV information may comprise a 2-bit field. The Source ID information may comprise an 8-bit field. The Destination ID information may comprise a 16-bit field. The HARQ feedback enabled/disabled indicator information may comprise a 1-bit field.

The Zone ID information may comprise a 12-bit field (e.g., as defined in clause 5.8.11 of 3GPP TS 38.331). The Communication range requirement information may comprise a 4-bit field determined by higher layer parameter sl-ZoneConfigMCR-Index.

Regarding SCI format 2-C, the SCI format 2-C is used for the decoding of PSSCH and providing inter-UE coordination information or requesting inter-UE coordination information.

The following information is transmitted by means of the SCI format 2-C: HARQ process number, NDI, RV, Source ID, Destination ID, HARQ feedback enabled/disabled indicator, CSI request, and Providing/Requesting indicator.

The HARQ process number information may comprise a 4-bit field. The NDI information may comprise a 1-bit field. The RV information may comprise a 2-bit field. The Source ID information may comprise an 8-bit field. The Destination ID information may comprise a 16-bit field.

The HARQ feedback enabled/disabled indicator information may comprise a 1-bit field. The CSI request information may comprise a 1-bit field. The Providing/Requesting indicator information may comprise a 1-bit field, where value 0 indicates SCI format 2-C is used for providing inter-UE coordination information and value 1 indicates SCI format 2-C is used for requesting inter-UE coordination information.

If the ‘Providing/Requesting indicator’ field is set to 0, all the remaining fields are set as follows: Resource combinations, First resource location, Reference slot location, and Lowest subChannel indices.

The Resource combinations information may comprise a field with size of 2.

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ + 9 + Y$$

bits (e.g., as defined in Clause 8.1.5A of 3GPP TS 38.214), where Y=┌log₂ N_{rsv_period}┐ and N_{rsv_period} is the number of entries in the higher layer parameter sl-ResourceReservePeriodList, if higher layer parameter sl-MultiReserveResource is configured; and Y=0, otherwise.

$${N}_{subChannel}^{SL}$$

is the number of subchannels in a resource pool provided by the higher layer parameter sl-NumSubchannel.

The First resource location information may comprise a 8-bit field (e.g., as defined in Clause 8.1.5A of 3GPP TS 38.214). The Reference slot location information may comprise a 1-bit field (10+┌log₂(10·2^{μ})┐) bits (e.g., as defined in Clause 8.1.5A of 3GPP TS 38.214), where μ (i.e., the subcarrier spacing (SCS) index) is defined in Table 4.2-1 of Clause 4.2 of 3GPP TS 38.211.

The Resource set type information may comprise a 1-bit field, where value 0 indicates preferred resource set and value 1 indicates non-preferred resource set. The Lowest subChannel indices information may comprise a field of size 2·

$$⌈ {log}_{2} {N}_{subChannel}^{SL} ⌉$$

bits as defined in Clause 8.1.5A of 3GPP TS 38.214.

If the ‘Providing/Requesting indicator’ field is set to 1, all the remaining fields are set as follows: Priority, Number of subchannels, Resource reservation period, Resource selection window location, Resource set type, and padding bits.

The priority information may comprise a 3-bit field (e.g., as specified in clause 5.4.3.3 of 3GPP TS 23.287 and clause 5.22.1.3.1 of 3GPP TS 38.321). Value ‘000’ of Priority field corresponds to priority value ‘l’, value ‘001’ of Priority field corresponds to priority value ‘2’, and so on.

The number of subchannels information may comprise a field with size of

$$⌈ {log}_{2} {N}_{subChannel}^{SL} ⌉$$

bits (e.g., as defined in Clause 8.1.4A of 3GPP TS 38.214).

The resource reservation period information may comprise a 1-bit field ┌log₂ N_{rsv_period}┐ bits (e.g., as defined in Clause 8.1.4A of 3GPP TS 38.214), where N_{rsv_period} is the number of entries in the higher layer parameter sl-ResourceReservePeriodList, if higher layer parameter sl-MultiReserveResource is configured; 0 bit otherwise.

The resource selection window location information may comprise a 1-bit field 2·(10+┌log₂(10·2^{μ})┐) bits (e.g., as defined in Clause 8.1.4A of 3GPP TS 38.214), where μ is defined in Table 4.2-1 of Clause 4.2 of 3GPP TS 38.211.

The resource set type information may comprise a 1-bit field 1 bit, where value 0 indicates a request for inter-UE coordination information providing preferred resource set and value 1 indicates a request for inter-UE coordination information providing non-preferred resource set, if higher layer parameter determineResourceSetTypeScheme1 is configured to ‘UE-B's request’; otherwise, 0 bit.

For operation in a same resource pool, zeros shall be appended to SCI format 2-C of which ‘Providing/Requesting indicator’ field is set to 1 until the payload size equals that of SCI format 2-C of which ‘Providing/Requesting indicator’ field is set to 0.

With regards to Sidelink operation on Unlicensed (i.e., shared) spectrum (SL-U), multi-consecutive slots transmission (MCSt) is supported for Mode 1 and Mode 2 resource allocation in SL-U.

FIG. 4 depicts an exemplary scenario 400 of multi-TTI DCI grant for 4 slots/TBs (arrows indicate which channel(s) control signaling applies to). The gNB 402 (i.e., an embodiment of the RAN node 208 and/or the NE 102) transmits DCI format 3_0 which comprises the SL grant for a 3 slots/TBs burst with common SCI-2. The Tx UE 302 transmits the TBs on Physical Sidelink Shared Channel (PSSCH) resources in consecutive slots i, i+1, i+2, and i+3. The Rx UE 304 generates SL HARQ feedback for the TBs of the multi-TTI burst and transmits the SL HARQ feedback on Physical Sidelink Feedback Channel (PSFCH) resources.

Further overhead reduction can be achieved by avoiding repetition of common SCI-2 parameters (if any) across TBs/slots such as destination ID, cast type indicator, zone ID, etc.

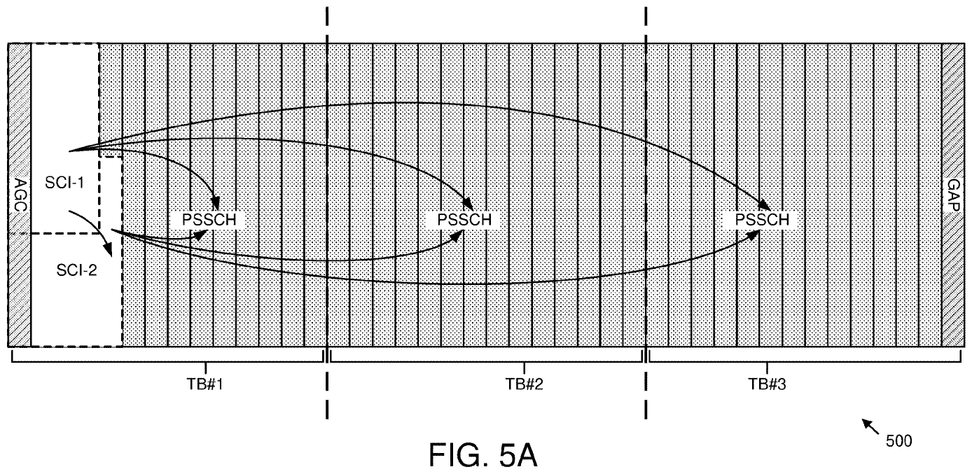

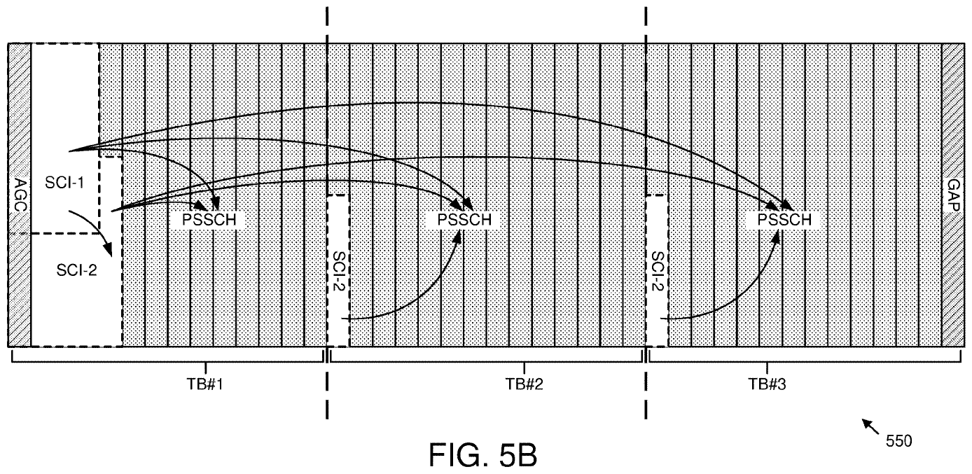

FIG. 5A depicts a first exemplary scenario 500 of multi-TTI SCI-1 grant for a 3 slots/TBs burst with common SCI-2 (arrows indicate which channel(s) control signaling applies to). Only a single SCI-2 is transmitted in the first slot with the understanding that its parameters/fields are applicable to all subsequent slots/TBs in the transmission. Note that Automatic gain control (AGC) and gap symbols within the burst are used as additional PSSCH symbols.

FIG. 5B depicts a second exemplary scenario 550 of multi-TTI SCI-1 grant for a 3 slots/TBs burst with TB-specific SCI-2 indicating TB-specific SCI-2 (and, possibly, SCI-1) parameters (arrows indicate which channel(s) control signaling applies to). In case an SCI-2 parameter/field is not common to all TBs, TB-specific SCI-2 can appear along with the PSSCH of a TB that indicates the “correct” parameter for that TB. Note that AGC and gap symbols within the burst are used as additional PSSCH symbols.

One example case is that of TBs with the same SCI-2 parameters but directed to different destination IDs. In that case, each PSSCH is transmitted with TB-specific SCI-2 that is used to indicate the corresponding destination ID.

Described below are solutions to allow for efficient multi-slot SCI scheduling. SCI-2 scheduling PSSCH in the slot N may indicate the presence or absence of SCI-2 scheduling PSSCH in the slot N+1 or contains a bitmap of SCI-2 presence or absence indicator in all subsequent slots until the end of the channel occupancy time (COT) duration, may also indicate the corresponding SCI-2 format in slot N+1, or contains bitmap of SCI-2 format for all SCI-2 transmission in all subsequent slots until the end of the COT duration.

A new SCI-2 format may be defined containing content from both SCI format 2A and SCI format 2B and may contain SCI-2 format indicator in the payload and according to the SCI-2 format indicator the content of the SCI-2 may be interpreted as SCI-2A or SCI-2B.

The SCI-1 may indicate the presence or absence of SCI-2 scheduling PSSCH in slot N+1, or provides a bitmap of SCI-2 presence or absence indicator in all subsequent slots until the end of the COT duration. A COT structure indicator may provide information on the presence or absence of SCI-1 and SCI-2 in position as a bitmap in all subsequent slots until the end of the COT duration. Beneficially, the solutions described herein improve signaling efficiency as the SCI-1 nor SCI-2 need not be transmitted in all time slot.

In various embodiments, for the case of a multi-slot grant, the SCI-1 may reserve more than one contiguous time domain resource (e.g., slot) for PSSCH transmission and may also indicate (e.g., using a bitmap) those slots containing presence or absence of SCI-2 in all subsequent slots until the end of the COT duration. In various embodiments, the SCI-1 contains a bitmap used to indicate the presence (or absence) of SCI-2, where the size of the bitmap is equal to the maximum COT duration provided by SL Channel Access Priority Class (CAPC). Here, the Least Significant Bit (LSB) of the bitmap starts from the slot number when SCI-1 was transmitted, and the Most Significant Bit (MSB) contains the slot number where COT duration ends.

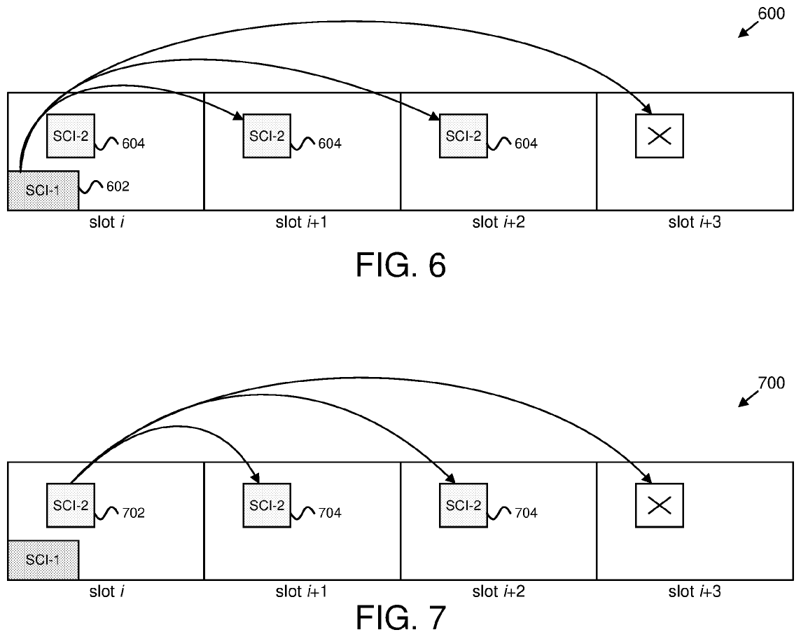

FIG. 6 depicts an exemplary scenario 600 where the SCI-1 602 in the first slot (e.g., slot i) is used to schedule the presence or absence of SCI-2 604 in the other slots of a multi-slot grant (e.g., slot i+1, slot i+2, slot i+3). In the depicted embodiment, the SCI-1 602 indicates that SCI-2 604 is present in slot i+1 and i+2, but is not present in slot i+3.

In some embodiments, the SCI-1 may contain a bitmap of SCI-2 format type or SCI-2 sizes appearing in slots where the SCI-2 is scheduled since the Tx UE 302 may transmit PSSCH to one or more Rx UEs/destination IDs using one or more cast types/HARQ feedback types. In another implementation, the SCI-1 may also contain bitmap of SCI-2 format for all SCI-2 transmission in all subsequent slots until the end of the COT duration.

In another implementation, SCI-1 may reserve more than one contiguous time domain resource for PSSCH transmission, which means the Rx UE 304 may not try to decode SCI-1 in the subsequent slot which may be indicated in the SCI-1 using the presence/absence of SCI-1 in the next slots until the COT duration or providing a bitmap of presence/absence of SCI-1 in the next subsequent slot until the end of the COT duration.

For example, after the Rx UE 304 receives the SCI-1 with contiguous time domain allocation or explicit indicator containing presence/absence of SCI-1 in the next slots, the Rx UE 304 may not try decoding SCI-1 in the next subsequent slots. Rather, the Rx UE 304 may wait to try to decode SCI-1 until after the end of the contiguously time domain allocation within the remaining COT duration.

In some embodiments, the COT structure indicator may provide information on the presence/absence of SCI-1 and/or SCI-2 in all subsequent slots until the end of the COT duration. In certain embodiments, the COT structure indicator includes a bitmap that indicates the presence/absence of SCI-1 and/or SCI-2 in all subsequent slots.

In some embodiments, the SCI-2 can be transmitted in every time slot and may contain content from both SCI format 2-A and SCI format 2-B. In certain embodiments, the SCI-2 may contain a SCI-2 format indicator in the payload and, according to the SCI-2 format indicator, the content of the SCI-2 may be interpreted as SCI-2A or SCI-2B. Because the size of the SCI-2 is same in every time slot, the Rx UE 304 does not need to blind decode the SCI-2.

In some embodiments, a first SCI-2 may indicate (e.g., using a bitmap) those slots containing presence or absence of SCI-2 or the respective SCI-2 format types, or both, in all subsequent slots, i.e., until the end of the COT duration. In certain embodiments, the first SCI-2 contains a bitmap used to indicate the presence (or absence) of SCI-2, where the size of the bitmap is equal to the maximum COT duration provided by SL Channel Access Priority Class (CAPC). Here, the Least Significant Bit (LSB) of the bitmap starts from the slot number when SCI-1 was transmitted, and the Most Significant Bit (MSB) contains the slot number where COT duration ends.

FIG. 7 depicts an exemplary scenario 700 where an initial SCI-2 702 in the first slot (e.g., slot i) is used to schedule the presence (or absence) of subsequent SCI-2 704 in the other slots of a multi-slot grant (e.g., slot i+1, slot i+2, slot i+3). In various embodiments, the initial SCI-2 702 uses a bitmap to indicate the presence (or absence) of the subsequent SCI-2 704 in the other slots. In the depicted embodiment, the initial SCI-2 702 indicates that subsequent SCI-2 704 is present in slot i+1 and i+2, but is not present in slot i+3.

In others embodiment, a respective SCI-2 scheduling PSSCH in the slot N may indicate the presence (or absence) of a subsequent SCI-2 scheduling PSSCH in the slot N+1. In certain embodiments, the SCI-2 in the slot N may also indicate the corresponding SCI-2 format type for the subsequent SCI-2 in the slot N+1.

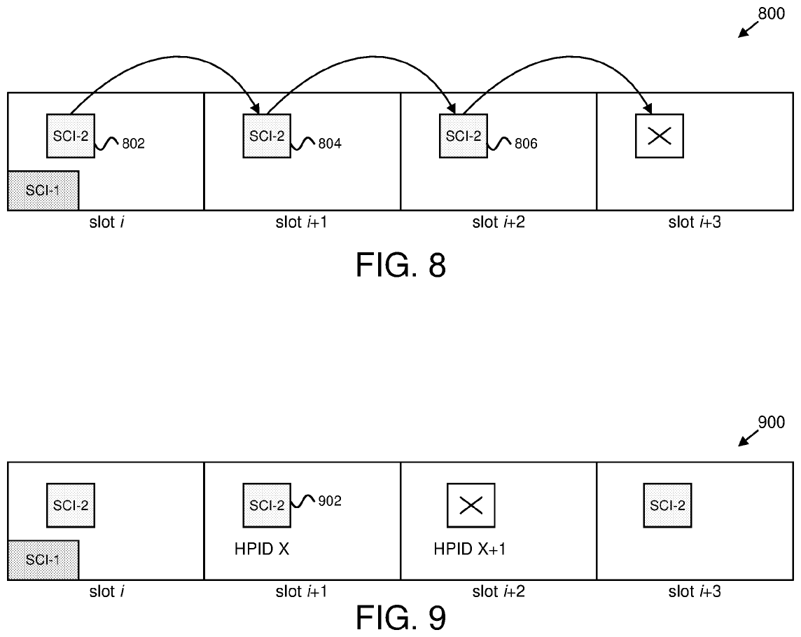

FIG. 8 depicts an exemplary scenario 800 where SCI-2 in a given slot is used to schedule the presence (or absence) of SCI-2 in the next/subsequent slot of a multi-slot grant. Accordingly, a first SCI-2 802 in slot i is used to indicate the presence (or absence) of second SCI-2 804 in slot i+1, and (if present) the second SCI-2 804 in slot i+1 is used to indicate the presence (or absence) of third SCI-2 806 in slot i+2, etc. In the depicted embodiment, the first SCI-2 802 in slot i indicates that the second SCI-2 804 is present in slot i+1, and the second SCI-2 804 in slot i+1 indicates that the third SCI-2 806 is present in slot i+2, and the third SCI-2 806 in slot i+2 indicates the SCI-2 is absent (i.e., no SCI-2 is present) in slot i+3.

According to aspects of a second solution, the absence of SCI-2 in a slot N+1 (of a multi-slot grant) implicitly indicates that a HARQ process ID is to be incremented (i.e., by one) as compared to the HARQ process ID associated with the slot N. For SL operation, up to 16 HARQ processed IDs may be configured. Usually, the HARQ process ID for a particular TB in PSSCH is indicated in the SCI-2 scheduling the PSSCH. However, when SCI-2 is absent in a time slot (e.g., to improve efficiency, in accordance with the aspects described above), the HARQ process ID may be autonomously incremented by one from the HARQ process ID indicated in the previous slots where the Tx UE 302 transmitted SCI-2.

In some embodiments of the second solution, the SCI-2A transmitted in slot N may indicate type of TB transmission in the next slot N+1 which may be a repetition, blind re-transmission, or new TB transmission. The HARQ process ID usually is not updated for repetition and blind re-transmission in the next slot. One SCI-2 may provide multi-slot grant by scheduling PSSCH in multiple slots contiguously while indicate the number of contiguous slots in the SCI-2 using the time domain resource indicator and while the frequency domain resource indicator may indicate the subchannel index of the starting slot and subsequent subchannel index for contiguous transmission remains until the next SCI-1 transmission.

In certain embodiments, the SCI-2 transmitted in slot N may indicate the subchannel index for the next SCI-2 scheduling PSSCH in slot N+1 and thereafter which may the absolute subchannel index or a relative subchannel index with the respect to slot N.

FIG. 9 depicts an exemplary scenario 900 of HARQ process ID (HPID) incrementing, in accordance with aspects of the second solution. In the depicted scenario 900, SCI-2 is present in slots i, i+1 and i+3, but not in slot i+2. Therefore, the SCI-2 indicates the HPID for the TBs transmitted (e.g., on PSSCH) in slots i, i+1 and i+3. However, for slot i+2, there is no SCI-2 to indicate the HPID for a TB transmitted in slot i+2. Accordingly, if the HPID (indicated by SCI-2 902) associated with slot i+1 is ‘X’, then the HPID associated with slot i+2 is implicitly understood to be ‘X+1’.

According to aspects of a third solution, after receiving the DCI format 3_0 from a gNB, e.g., as part of the gNB scheduling SL resources containing contiguous time allocation for scheduling PSSCH in the next subsequent slot contiguously, the Tx UE 302 may perform the Logical Channel Prioritization (LCP) procedure only once at the beginning of the first slot and may schedule SL data contiguously for the same source/destination ID. Here, the next LCP step is performed when the SL data needs to be transmitted for the second source-destination ID. In another implementation, the LCP procedure is performed in every slot.

According to aspects of a fourth solution, SCI-1 or SCI-2 may indicate DMRS bundling information for multiple slots while indicating the DMRS time resource across a slot boundary. Alternatively, the SCI-1 or SCI-2 may indicate DMRS bundling information for the same source/destination ID for a number of time slots. Such DMRS bundling may be performed when the PSSCH may be transmitted to the same Rx UE (i.e., destination ID) over multiple contiguous slots. After receiving the DMRS bundling information, the Rx UE may buffer DMRS across slots to perform the joint channel estimations, thereby leveraging the gain from this combined channel estimation.

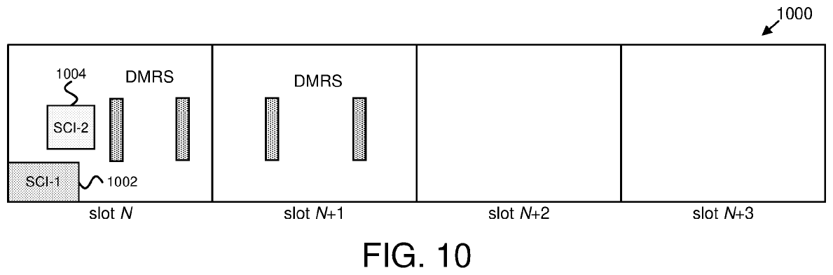

FIG. 10 depicts an exemplary scenario 1000 of DMRS bundling indicator in SCI-1 1002 or SCI-2 1004, in accordance with aspects of the present disclosure. Moreover, the DMRS bundling indicator may be used to indicate when and how to combine the DMRS from different slots.

In one implementation, the SCI-1 1002 transmitted in slot N may include a DMRS bundling indicator considering DMRS bundling across slot N and slot N+1 to perform joint channel estimation. In other words, the Tx UE may indicate to an Rx UE that the DMRS in slots N and N+1 are associated with the same destination(s). In another example, the position of the DMRS in the next slot may be shifted by one time domain symbol to enable channel estimates.

In another implementation, the SCI-1 1002 transmitted in slot N may include a DMRS bundling indicator considering DMRS bundling across slot N and slot N+1 to perform joint channel estimate in slot N+1. While the above implementation describe the DMRS bundling indicator contained in the SCI-1 1002, in other embodiments the DMRS bundling indicator may be contained in the SCI-2 1004.

In another implementation, the SCI-1 1002 transmitted in slot N may also indicate the absence of DMRS in slot N+1 (or any other subsequent slots) to enable DMRS-less transmission and to avoid blind DMRS detection. The SCI-1 1002 may also indicate (e.g., using a bitmap) those slots (of the multi-slot grant) where DMRS is not transmitted.

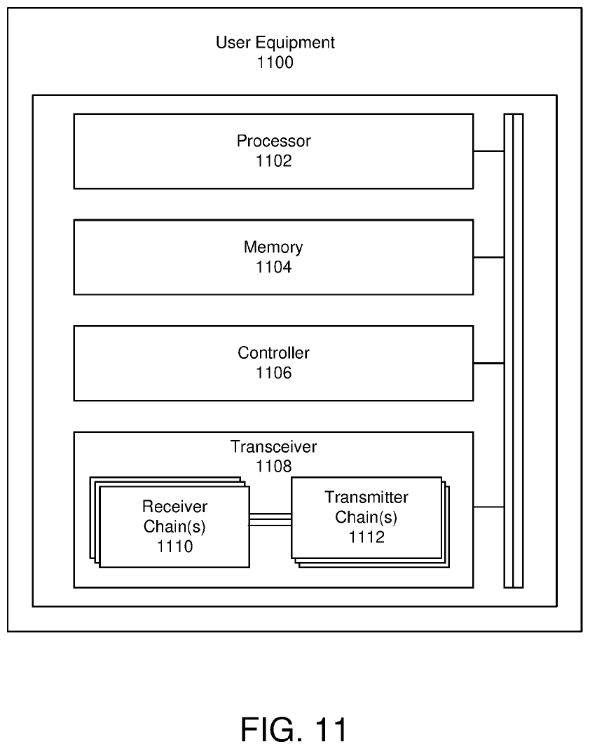

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, a Field Programable Gate Array (FPGA), or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the Tx UE functions described herein (e.g., executing, by the processor 1102, instructions stored in the memory 1104). For example, the processor 1102 may support wireless communication at the UE 1100 in accordance with examples as disclosed herein. The UE 1100 may be configured to support a means for initiating sidelink communication associated with a COT.

The UE 1100 may be configured to support a means for transmitting a first-stage SCI (SCI-1) scheduling a plurality of contiguous slots (i.e., timeslots) associated with the COT. In some implementations, the SCI-1 indicates the presence or absence of a respective second-stage SCI (SCI-2) in each corresponding slot of the plurality of contiguous slots. In certain implementations, the SCI-1 indicates a SCI format type or SCI size, or both, for each SCI-2 associated with the COT.

In certain implementations, the UE 1100 may be configured to transmit the SCI-1 in a first slot of the plurality of contiguous slots (i.e., transmission of the 1st-stage SCI occurs in the first of N slots). In one embodiment, a respective SCI-1 is omitted from the remainder of the plurality of contiguous slots (i.e., the UE 1100 does not transmit SCI-1 in subsequent slots of the COT). In another embodiment, the SCI-1 comprises a bitmap for indicating the presence or absence of a subsequent SCI-1 in a remainder of the plurality of contiguous slots.

The UE 1100 may be configured to support a means for indicating the presence or absence of a respective SCI in a corresponding slot of the plurality of contiguous slots. In some implementations, to indicate the presence or absence of the respective SCI, the UE 1100 may be configured to transmit a SCI-2 in a respective slot. In such embodiments, the SCI-2 indicates the presence or absence of a subsequent SCI-2 in a subsequent slot of the plurality of contiguous slots.

In some implementations, to indicate the presence or absence of the respective SCI, the UE 1100 may be configured to transmit COT structure information in a first slot of the plurality of contiguous slots. In such embodiments, the COT structure information indicates the presence or absence of SCI-1 or SCI-2, or both, in each subsequent slot of the plurality of contiguous slots.

The UE 1100 may be configured to support a means for transmitting a plurality of TBs during the plurality of contiguous slots. In some implementations, for each slot of the plurality of contiguous slots that carries a SCI-2, the SCI-2 indicates a HARQ process identifier (HPID) associated with a TB transmitted during a respective slot. In such embodiments, for each remaining slot of the plurality of contiguous slots, the UE 1100 may be configured to determine a respective HPID by incrementing a previous indicated HPID.

In some implementations, the processor 1102 and the memory 1104 coupled with the processor 1102 may be configured to cause the UE 1100 to perform one or more of the Rx UE functions described herein (e.g., executing, by the processor 1102, instructions stored in the memory 1104). For example, the processor 1102 may support wireless communication at the UE 1100 in accordance with examples as disclosed herein. The UE 1100 may be configured to support a means for receiving a first-stage SCI (SCI-1) scheduling a plurality of contiguous slots (i.e., timeslots) associated with a COT.

In some implementations, the SCI-1 indicates the presence or absence of a respective second-stage SCI (SCI-2) in each corresponding slot of the plurality of contiguous slots. In certain implementations, the at least one processor is configured to cause the UE to receive the SCI-1 in a first slot of the plurality of contiguous slots (i.e., reception of the SCI-1 occurs in the first of N slots). In certain implementations, the SCI-1 indicates a SCI format type or SCI size, or both, for each SCI-2 associated with the COT.

The UE 1100 may be configured to support means for receiving an indication of the presence or absence of a respective SCI in a corresponding slot of the plurality of contiguous slots. In some implementations, to receive the indication of the presence (or absence) of the respective SCI, the UE 1100 may be configured to receive a SCI-2 in a respective slot. In such embodiments, the SCI-2 indicates the presence or absence of a subsequent SCI-2 in a subsequent slot of the plurality of contiguous slots.

In some implementations, to receive the indication of the presence (or absence) of the respective SCI, the UE 1100 may be configured to receive COT structure information in a first slot of the plurality of contiguous slots. In such embodiments, the COT structure information indicates the presence or absence of SCI-1 or SCI-2, or both, in each subsequent slot of the plurality of contiguous slots.

The UE 1100 may be configured to support means for receiving at least one TB during the plurality of contiguous slots and means for transmitting HARQ feedback corresponding to the at least one TB. In some implementations, for each slot of the plurality of contiguous slots that carries a SCI-2, the SCI-2 indicates a HPID associated with a TB received during a respective slot. In such embodiments, for each remaining slot of the plurality of contiguous slots, the UE 1100 may be configured to determine a respective HPID by incrementing a previous indicated HPID.

In some implementations, a SCI in a particular slot indicates DMRS bundling for multiple slots. In such embodiments, the UE 1100 may be configured to perform joint channel estimation using the DMRS of the multiple slots. In certain implementations, the SCI in the particular slot indicates DMRS bundling across the particular slot (e.g., slot N) and a next slot (e.g., slot N+1) of the plurality of contiguous slots.

The controller 1106 may manage input and output signals for the UE 1100. The controller 1106 may also manage peripherals not integrated into the UE 1100. In some implementations, the controller 1106 may utilize an operating system (OS) such as iOS®, ANDROID®, WINDOWS®, or other operating systems (OSes). In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receiving the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receiving signal and obtain the transmitted data by reversing the modulation technique applied during transmission of the signal. The receiver chain 1110 may include at least one decoder for decoding and processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

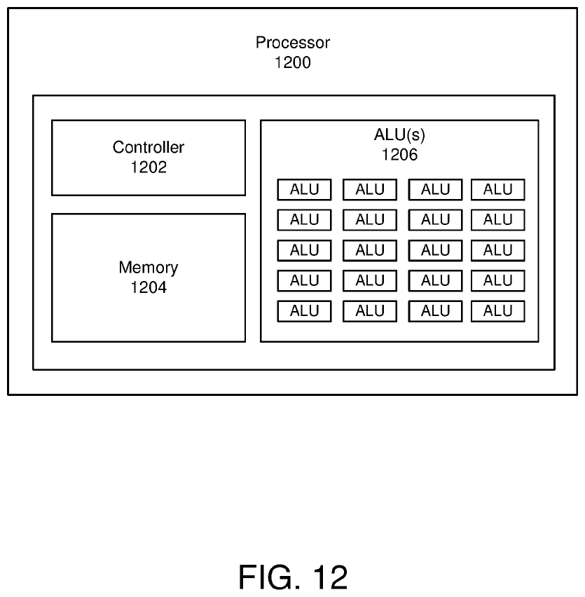

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory address of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, arithmetic logic units (ALUs), and other functional units of the processor 1200.

The memory 1204 may include one or more caches (e.g., memory local to or included in the processor 1200 or other memory, such RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, the controller 1202, and the memory 1204 may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. For example, the processor 1200 may perform one or more of the Tx UE functions described herein. The processor 1200 may be configured to or operable to support a means for initiating sidelink communication associated with a COT.

The processor 1200 may be configured to support a means for transmitting a first-stage SCI (SCI-1) reserving a plurality of contiguous slots associated with the COT. In some implementations, the SCI-1 indicates the presence or absence of a respective second-stage SCI (SCI-2) in each corresponding slot of the plurality of contiguous slots. In certain implementations, the SCI-1 indicates a SCI format type or SCI size, or both, for each SCI-2 associated with the COT.

In certain implementations, the processor 1200 may be configured to transmit the SCI-1 in a first slot of the plurality of contiguous slots (i.e., transmission of the 1st-stage SCI occurs in the first of N slots). In one embodiment, a respective SCI-1 is omitted from the remainder of the plurality of contiguous slots (i.e., the processor 1200 does not transmit SCI-1 in subsequent slots of the COT). In another embodiment, the SCI-1 comprises a bitmap for indicating the presence or absence of a subsequent SCI-1 in a remainder of the plurality of contiguous slots.

The processor 1200 may be configured to support a means for indicating the presence or absence of a respective SCI in a corresponding slot of the plurality of contiguous slots. In some implementations, to indicate the presence or absence of the respective SCI, the processor 1200 may be configured to transmit a SCI-2 in a respective slot. In such embodiments, the SCI-2 indicates the presence or absence of a subsequent SCI-2 in a subsequent slot of the plurality of contiguous slots.

In some implementations, to indicate the presence or absence of the respective SCI, the processor 1200 may be configured to transmit COT structure information in a first slot of the plurality of contiguous slots. In such embodiments, the COT structure information indicates the presence or absence of SCI-1 or SCI-2, or both, in each subsequent slot of the plurality of contiguous slots.

The processor 1200 may be configured to support a means for transmitting a plurality of TBs during the plurality of contiguous slots. In some implementations, for each slot of the plurality of contiguous slots that carries a SCI-2, the SCI-2 indicates a HARQ process identifier (HPID) associated with a TB transmitted during a respective slot. In such embodiments, for each remaining slot of the plurality of contiguous slots, the processor 1200 may be configured to determine a respective HPID by incrementing a previous indicated HPID.

The processor 1200 may perform one or more of the Rx UE functions described herein. The processor 1200 may be configured to or operable to support a means for receiving a first-stage SCI (SCI-1) reserving a plurality of contiguous slots associated with a COT. In some implementations, the SCI-1 indicates the presence or absence of a respective second-stage SCI (SCI-2) in each corresponding slot of the plurality of contiguous slots.

In certain implementations, the at least one processor is configured to cause the UE to receive the SCI-1 in a first slot of the plurality of contiguous slots (i.e., reception of the SCI-1 occurs in the first of N slots). In certain implementations, the SCI-1 indicates a SCI format type or SCI size, or both, for each SCI-2 associated with the COT.

The processor 1200 may be configured to support means for receiving an indication of the presence or absence of a respective SCI in a corresponding slot of the plurality of contiguous slots. In some implementations, to receive the indication of the presence (or absence) of the respective SCI, the processor 1200 may be configured to receive a SCI-2 in a respective slot. In such embodiments, the SCI-2 indicates the presence or absence of a subsequent SCI-2 in a subsequent slot of the plurality of contiguous slots.

In some implementations, to receive the indication of the presence (or absence) of the respective SCI, the processor 1200 may be configured to receive COT structure information in a first slot of the plurality of contiguous slots. In such embodiments, the COT structure information indicates the presence or absence of SCI-1 or SCI-2, or both, in each subsequent slot of the plurality of contiguous slots.

The processor 1200 may be configured to support means for receiving at least one TB during the plurality of contiguous slots and means for transmitting HARQ feedback corresponding to the at least one TB. In some implementations, for each slot of the plurality of contiguous slots that carries a SCI-2, the SCI-2 indicates a HPID associated with a TB received during a respective slot. In such embodiments, for each remaining slot of the plurality of contiguous slots, the processor 1200 may be configured to determine a respective HPID by incrementing a previous indicated HPID.

In some implementations, a SCI in a particular slot indicates DMRS bundling for multiple slots. In such embodiments, the processor 1200 may be configured to perform joint channel estimation using the DMRS of the multiple slots. In certain implementations, the SCI in the particular slot indicates DMRS bundling across the particular slot (e.g., slot N) and a next slot (e.g., slot N+1) of the plurality of contiguous slots.

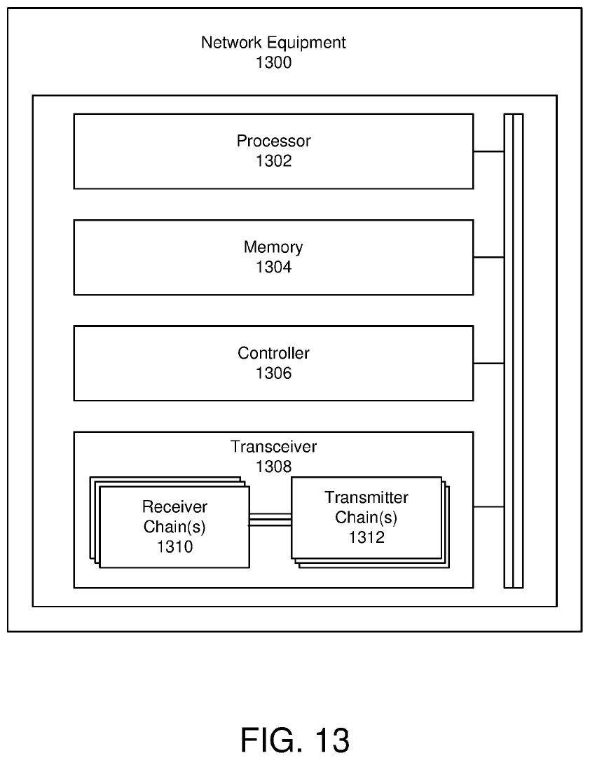

FIG. 13 illustrates an example of a NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communication at the NE 1300 in accordance with examples as disclosed herein.

The controller 1306 may manage input and output signals for the NE 1300. The controller 1306 may also manage peripherals not integrated into the NE 1300. In some implementations, the controller 1306 may utilize an OS such as iOS®, ANDROID®, WINDOWS®, or other OSes. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas for receiving the signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receiving signal and obtain the transmitted data by reversing the modulation technique applied during transmission of the signal. The receiver chain 1310 may include at least one decoder for decoding and processing the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

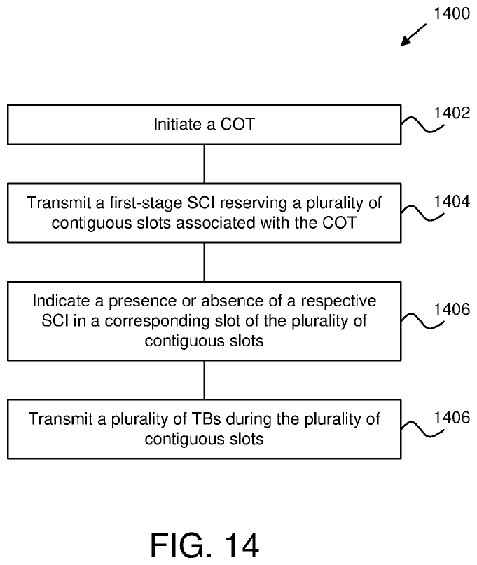

FIG. 14 illustrates a flowchart of a method 1400 in accordance with aspects of the present disclosure. The operations of the method 1400 may be implemented by a Tx UE as described herein. In some implementations, the Tx UE may execute a set of instructions to control the function elements of the Tx UE to perform the described functions.

At Step 1402, the method 1400 may include initiating a COT. The operations of Step 1402 may be performed in accordance with examples as described herein. In some implementations, aspects of the operations of Step 1402 may be performed by a UE as described with reference to FIG. 11.

At Step 1404, the method 1400 may include transmitting a first-stage SCI (SCI-1) reserving a plurality of contiguous slots associated with the COT. The operations of Step 1404 may be performed in accordance with examples as described herein. In some implementations, aspects of the operations of Step 1404 may be performed by a UE as described with reference to FIG. 11.

At Step 1406, the method 1400 may include indicating the presence or absence of a respective SCI in a corresponding slot of the plurality of contiguous slots. The operations of Step 1406 may be performed in accordance with examples as described herein. In some implementations, aspects of the operations of Step 1406 may be performed a UE as described with reference to FIG. 11.

At Step 1408, the method 1400 may include transmitting a plurality of TBs during the plurality of contiguous slots. The operations of Step 1408 may be performed in accordance with examples as described herein. In some implementations, aspects of the operations of Step 1408 may be performed a UE as described with reference to FIG. 11.

It should be noted that the method 1400 described herein describes one possible implementation, and that the operations and the steps may be rearranged or otherwise modified and that other implementations are possible.

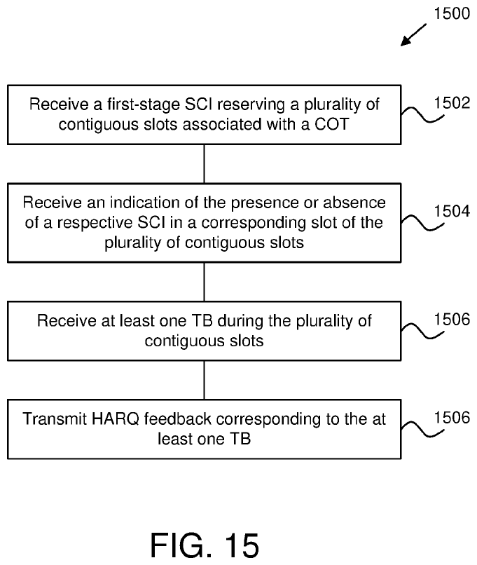

FIG. 15 illustrates a flowchart of a method 1500 in accordance with aspects of the present disclosure. The operations of the method 1500 may be implemented by a Rx UE as described herein. In some implementations, the Rx UE may execute a set of instructions to control the function elements of the Rx UE to perform the described functions.

At Step 1502, the method 1500 may include receiving a first-stage SCI (SCI-1) reserving a plurality of contiguous slots associated with a COT. The operations of Step 1502 may be performed in accordance with examples as described herein. In some implementations, aspects of the operations of Step 1502 may be performed by a UE as described with reference to FIG. 11.

At Step 1504, the method 1500 may include receiving an indication of the presence or absence of a respective SCI in a corresponding slot of the plurality of contiguous slots. The operations of Step 1504 may be performed in accordance with examples as described herein. In some implementations, aspects of the operations of Step 1504 may be performed by a UE as described with reference to FIG. 11.

At Step 1506, the method 1500 may include receiving at least one TB during the plurality of contiguous slots. The operations of Step 1506 may be performed in accordance with examples as described herein. In some implementations, aspects of the operations of Step 1506 may be performed by a UE as described with reference to FIG. 11.

At Step 1508, the method 1500 may include transmitting HARQ feedback corresponding to the at least one TB. The operations of Step 1508 may be performed in accordance with examples as described herein. In some implementations, aspects of the operations of Step 1508 may be performed by a UE as described with reference to FIG. 11.

It should be noted that the method 1500 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
initiate a channel occupancy time (COT);
transmit a first-stage sidelink control information (SCI) scheduling a plurality of contiguous slots associated with the COT;
indicate a presence or an absence of a respective SCI in a corresponding slot of the plurality of contiguous slots; and
transmit a plurality of transport blocks (TBs) during the plurality of contiguous slots.

2. The UE of claim 1, wherein the first-stage SCI indicates the presence or the absence of a respective second-stage SCI in each corresponding slot of the plurality of contiguous slots.

3. The UE of claim 2, wherein the at least one processor is configured to cause the UE to transmit the first-stage SCI in a first slot of the plurality of contiguous slots.

4. The UE of claim 3, wherein a respective first-stage SCI is omitted from a remainder of the plurality of contiguous slots.

5. The UE of claim 3, wherein the first-stage SCI comprises a bitmap for indicating the presence or the absence of a subsequent first-stage SCI in a remainder of the plurality of contiguous slots.

6. The UE of claim 2, wherein the first-stage SCI indicates a SCI format type or SCI size, or both, for each respective second-stage SCI associated with the COT.

7. The UE of claim 1, wherein to indicate the presence or the absence of the respective SCI, the at least one processor is configured to cause the UE to transmit COT structure information in a first slot of the plurality of contiguous slots, wherein the COT structure information indicates the presence or the absence of first-stage SCI or second-stage SCI, or both, in each subsequent slot of the plurality of contiguous slots.

8. The UE of claim 1, wherein to indicate the presence or the absence of the respective SCI, the at least one processor is configured to cause the UE to transmit a second-stage SCI in a respective slot, wherein the second-stage SCI indicates the presence or the absence of a subsequent second-stage SCI in a subsequent slot of the plurality of contiguous slots.

9. The UE of claim 1, wherein for each slot of the plurality of contiguous slots that carries a respective second-stage SCI, the respective second-stage SCI indicates a hybrid automatic repeat request (HARQ) process identifier (HPID) associated with a TB transmitted during a respective slot, and wherein for each remaining slot of the plurality of contiguous slots, the at least one processor is configured to cause the UE to determine a respective HPID by incrementing a previous indicated HPID.

10. A method performed by a user equipment (UE), the method comprising:
initiating a channel occupancy time (COT);
transmitting a first-stage sidelink control information (SCI) reserving a plurality of contiguous slots associated with the COT;
indicating a presence or an absence of a respective SCI in a corresponding slot of the plurality of contiguous slots; and
transmitting a plurality of transport blocks (TBs) during the plurality of contiguous slots.

11. A user equipment (UE) for wireless communication, comprising:
at least one memory; and
at least one processor coupled with the at least one memory and configured to cause the UE to:
receive a first-stage sidelink control information (SCI) scheduling a plurality of contiguous slots associated with a channel occupancy time (COT);
receive an indication of a presence or an absence of a respective SCI in a corresponding slot of the plurality of contiguous slots;
receive at least one transport block (TB) during the plurality of contiguous slots; and
transmit hybrid automatic repeat request (HARQ) feedback corresponding to the at least one TB.

12. The UE of claim 11, wherein the first-stage SCI indicates the presence or the absence of a respective second-stage SCI in each corresponding slot of the plurality of contiguous slots.

13. The UE of claim 12, wherein the at least one processor is configured to cause the UE to receive the first-stage SCI in a first slot of the plurality of contiguous slots.

14. The UE of claim 12, wherein the first-stage SCI indicates a SCI format type or SCI size, or both, for each respective second-stage SCI associated with the COT.

15. The UE of claim 11, wherein to receive the indication of the presence or the absence of the respective SCI, the at least one processor is configured to cause the UE to receive COT structure information in a first slot of the plurality of contiguous slots, wherein the COT structure information indicates the presence or the absence of first-stage SCI or second-stage SCI, or both, in each subsequent slot of the plurality of contiguous slots.

16. The UE of claim 11, wherein to receive the indication of the presence or the absence of the respective SCI, the at least one processor is configured to cause the UE to receive a second-stage SCI in a respective slot, wherein the second-stage SCI indicates the presence or the absence of a subsequent second-stage SCI in a subsequent slot of the plurality of contiguous slots.

17. The UE of claim 11, wherein for each slot of the plurality of contiguous slots that carries a respective second-stage SCI, the respective second-stage SCI indicates a HARQ process identifier (HPID) associated with a TB received during a respective slot, and wherein for each remaining slot of the plurality of contiguous slots, the at least one processor is configured to cause the UE to determine a respective HPID by incrementing a previous indicated HPID.

18. The UE of claim 11, wherein a SCI in a particular slot indicates demodulation reference signal (DMRS) bundling for multiple slots, and wherein the at least one processor is configured to cause the UE to perform joint channel estimation using the DMRS of the multiple slots.

19. The UE of claim 18, wherein the SCI in the particular slot indicates DMRS bundling across the particular slot and a next slot of the plurality of contiguous slots.

20. A method performed by a user equipment (UE), the method comprising:
receiving a first-stage sidelink control information (SCI) reserving a plurality of contiguous slots associated with a channel occupancy time (COT);
receiving an indication of a presence or an absence of a respective SCI in a corresponding slot of the plurality of contiguous slots;
at least one transport block (TB) during the plurality of contiguous slots; and
transmitting hybrid automatic repeat request (HARQ) feedback corresponding to the at least one TB.
